(19) United States
(12) Patent Application Publication
(10) Pub. No.: US 2026/0003764 A1
(43) Pub. Date: Jan. 1, 2026

(54) EXECUTING OPERATING SYSTEMS BASED ON SOFTWARE BILL OF MATERIALS TO FACILITATE SAFETY COMPLIANCE

(71) Applicant: RED HAT, INC., Raleigh, NC (US)

(72) Inventors: Leonardo Rossetti, Sao Paulo (BR); Leigh Griffin, Waterford (IE)

(21) Appl. No.: 18/757,760

(22) Filed: Jun. 28, 2024

(51) Int. Cl. G06F 11/36

(52) U.S. Cl. CPC G06F 11/3604

(57) ABSTRACT

Compliance of an operating system with safety requirements can be evaluated and monitored using software bill of materials (SBOMs). For example, a system can receive first metadata indicative of a current state of an operating system. The operating system can be used to execute software services, and the operating system can be associated with a functional safety standard issued. The system can further determine whether the current state matches a verified state of the operating system based on the first metadata and based on second metadata indicative of the verified state. The second metadata can be stored in an operating system SBOM. Then, based on determining that the current state matches the verified state, the system can verify compliance of the operating system with the functional safety standard and execute, via the operating system, the software services.

### TECHNICAL FIELD

The present disclosure relates generally to software deployment and evaluation. More specifically, but not by way of limitation, this disclosure relates to executing operating systems based on software bill of materials to facilitate safety compliance.

### BACKGROUND

Many organizations around the globe have developed functional safety standards for software and electronics. Functional safety relates to reducing risks so that computing systems function safely in the event that there is a malfunction. One example of a functional safety standard is ISO 26262 for automotive electronics. Functional safety standards can be used to avoid or mitigate systematic failures and hardware failures to prevent hazardous operational situations. An operating system can be certified to a functional safety standard based on a target level of risk reduction. For example, an Automotive Safety Integrity Level (ASIL) assignment with respect to ISO 26262 has four possible levels of safety requirements: ASIL A, ASIL B, ASIL C, and ASIL D. ASIL D has the highest safety requirements of the four possible levels and includes the safety requirements of the three preceding levels.

### BRIEF DESCRIPTION OF THE DRAWINGS

FIG. 1 is a block diagram of an example of a computing environment for executing operating systems based on software bill of materials (SBOMs) to facilitate safety compliance according to some embodiments of the present disclosure.

FIG. 2 is a block diagram of an example of a computing system for executing operating systems based on SBOMs to facilitate safety compliance according to some embodiments of the present disclosure.

FIG. 3 is a flowchart of a process for executing operating systems based on SBOMs to facilitate safety compliance according to some embodiments of the present disclosure.

### DETAILED DESCRIPTION

A software developer or software development organization may want or need to comply with a functional safety standard issued by a standard-setting organization when developing an operating system. An operating system (OS) can include software components that are bundled together to manage hardware and software of a computing system at which the operating system is deployed. To determine compliance of the operating system with a functional safety standard, the software developer can test each of the software components of the operating system (e.g., a kernel, a shell, a file system, device drivers, a scheduler, I/O controllers, file management tools, etc.). But, separately testing each software component can be tedious and, consequently, can be a waste of computing resources.

Some examples of the present disclosure can overcome one or more of the issues mentioned above by a system that can evaluate operating system compliance with safety requirements of a functional safety standard using software bill of materials (SBOMs). For example, the system can generate one or more SBOMs for an operating system. An SBOM can store metadata that describes subcomponents of a piece of software. Accordingly, the SBOMs can include metadata describing the software components of the operating system. The metadata stored in the SBOMs can be related to compliance of the operating system with the functional safety standards. For example, the metadata can describe the software components of the operating system in a verified state (e.g., a state in which the operating system is compliant with the functional safety standard). As a result, the SBOMs can provide a secure and efficient mechanism for evaluating compliance of the operating system with the functional safety standard. For example, a current state of the operating system can be periodically compared to the verified state as indicated by the metadata in the SBOMs. In this way, the system can determine whether the operating system is compliant with the functional safety standard more efficiently and with less computing resources than would be used to separately test each software component for compliance.

In one particular example, an operating system of a computing device can be executing one or more software services. A system communicatively coupled with the computing device can receive first metadata indicative of a current state of the operating system. The first metadata can be indicative of the current state of the operating system by providing an overview how the operating system is functioning at the computing device at a point in time. For example, the first metadata can provide information about software processes, resources allocations, configuration settings, or the like being carried out or managed by the operating system. Examples of such metadata can include version information, performance metrics (e.g., response times), resource usage (e.g., CPU or memory usage), or the like for software components (e.g., a kernel, file system, etc.) of the operating system.

Additionally, the computing device can be associated with a functional safety standard issued by a standard-setting organization. Thus, the operating system of the computing device may have to satisfy one or more safety requirements of the functional safety standard to receive and maintain a functional safety certification. To determine whether the operating system satisfies the one or more safety requirements, the system can further receive second metadata indicative of a verified state of the operating system. The verified state of the operating system can be a state in which the operating system satisfies the safety requirements of the functional safety standard. Thus, the second metadata can include information associated with software processes, resources allocations, configuration settings, or the like being carried out by the operating system when the operating system is satisfying the safety requirements of the functional safety standard. The second metadata can be stored in an SBOM accessible to the system.

The system can then compare the first metadata to the second metadata to determine whether the current state matches the verified state. In other words, the system can determine whether the software processes, resources allocations, configuration settings, or a combination thereof being carried out or managed by the operating system are in line with the verified software processes, resources allocations, and configuration settings. If the software processes, resources allocations, and configuration settings are aligned (e.g., if first metadata and the second metadata indicate that the current state matches the verified state), it can be determined that the operating system is compliant with the functional safety standard. As a result, the operating system 124 can continue to execute the software services in compliance with the functional safety standard.

Illustrative examples are given to introduce the reader to the general subject matter discussed herein and are not intended to limit the scope of the disclosed concepts. The following sections describe various additional features and examples with reference to the drawings in which like numerals indicate like elements, and directional descriptions are used to describe the illustrative aspects, but, like the illustrative aspects, should not be used to limit the present disclosure.

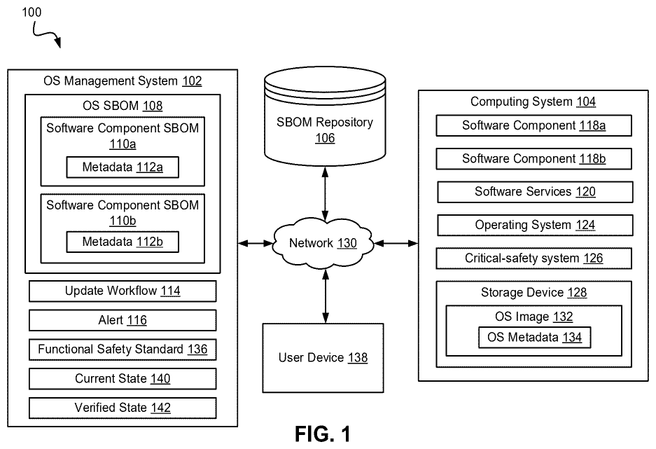

FIG. 1 is a block diagram of an example of a computing environment 100 for executing operating systems based on software bill of materials (SBOMs) to facilitate safety compliance according to some embodiments of the present disclosure. The computing environment 100 can be a cloud computing environment, a distributed computing environment (e.g., an edge computing environment), or the like. The computing environment 100 can include an operating system (OS) management system 102 and a computing system 104. The OS management system 102 may be part of the computing system 104 or the OS management system 102 may be external to and communicatively coupled with the computing system 104. For example, the OS management system 102 and the computing system 104 may be communicatively coupled via a network, such as a local area network (LAN), wide area network (WAN), the Internet, or any combination thereof. Examples of the computing system 104 can include an automotive system, medical device system, desktop computer, laptop computer, server, mobile phone, or tablet. The OS management system 102 can be or be associated with a workload lifecycle management system, a functional safety (FUSA) tooling system, or the like.

In some examples, one or more functional safety standards can be associated with the computing system 104 to avoid or mitigate systematic failures and hardware failures. For example, the computing system 104 can include a critical-safety system 126. The critical-safety system 126 can be a system that may cause hazardous operational situations (e.g., harm to a user of the computing system 104 or to an environment associated with the computing system 104) if the system fails or malfunctions. Thus, an operating system 124 of the computing system 104 can be required comply with a functional safety standard 136 for the critical-safety system 118.

A functional safety certification can provide confirmation that the operating system 124 complies with the one or more functional safety standards (e.g., the functional safety standard 136). The functional safety certification may be overseen by a standard-setting organization (e.g., International Organization for Standardization (ISO), International Electrotechnical Commission (IEC), etc.). Examples of the functional safety certification associated with transportation can include ISO 26262 for road vehicles, ISO 25119 for machinery associated with agriculture and forestry, and ISO 15998 for earth-moving machinery. Medical applications of the functional safety certification may include IEC 60601 for medical devices or IEC 62304 for medical device software. Additionally, compliance-related policies (e.g., the Health Insurance Portability and Accountability Act (HIPAA), etc.) may involve a similar certification with respect to safety. To receive or prevent invalidation of the functional safety certification for the operating system 124, the OS management system 102 can generate SBOMs associated with a verified state 142 of the operating system 124 and use the SBOMs to evaluate and monitor the operating system 124.

For example, the computing system 104 may include hardware, such as a storage device 1128, and software, such as the operating system 124 as well as software services 120 that can be executed by the operating system 124. The operating system 124, such as a Linux operating system, can manage the hardware and software resources for the computing system 104. For example, the operating system 124 can act as an intermediary between the software services 120 (and any other processes, applications, programs, software, etc. for the computing system 104) and hardware of the computing system 104. Files for the operating system 124 (e.g., as part of an operating system (OS) image 132 of the operating system 124) can be stored in the storage device 110. For example, the OS image 132 can include operating system (OS) metadata 134 for restoring or replicating the operating system 124 on another machine. The OS metadata 134 can include information related to system files, installed applications, configuration files, user data, boot loader, system state information, updates, network settings, or the like with respect to the computing system 104.

The OS management system 102 may use the OS metadata 134 in the OS image 132 to generate software component SBOMs 110a-b for software components 118a-b of the operating system 124. Examples of software components of the operating system 124 can include a kernel, a shell, a file system, device drivers, a scheduler, I/O controllers, file management tools, etc. An SBOM can be a list of subcomponents of a software component. For example, an SBOM can be a list of libraries, modules, packages, other dependencies, or the like used to build or run a software component. In other words, an SBOM can store metadata that describes the subcomponents of a piece of software. Accordingly, the software component SBOMs 110a-b can include metadata 112a-b associated with each of the software components 118a-b.

In some examples, the metadata 112a-b in the software component SBOMs 110a-b can include a name, version, component hash, or the like of each of the software components 118a-b or of dependencies of the software components 118a-b. The metadata 112a-b can further include licensing metadata, security vulnerability metadata, source location information, relationship metadata, or the like. Additionally, in some examples, the metadata 112a-b can be the metadata needed for functional safety certification of the operating system 124. In such examples, the metadata 112a-b can include results of tests performed on the software components 118a-b to demonstrate the software components 118a-b meets one or more safety requirements. For example, results from stress and fault injection tests performed with respect to a kernel of the operating system 124 can demonstrate that the kernel meets a safety level. In another example, results from testing can show that a file system can recover from an unexpected shutdown and can maintain data integrity in adverse conditions.

The OS management system 102 may further utilize digital signatures, checksums, or the like to secure each of the software component SBOMs 110a-b. For example, a digital signature can be associated with a first software component SBOM 110a. The digital signature can be generated using a cryptographic algorithm that generates a hash value via a hash function and then encrypts the hash value with an encryption key. Then, to verify that the first software component SBOM 110a has not been tampered with, the digital signature can be decrypted, and the hash function can be used to generate another hash value. If the hash value and the digital signature match, it can be concluded that the SBOM has not been tampered with. If the hash value and the digital signature do not match, it can be concluded that first metadata 112a in the first software component SBOM 110a may have been altered or corrupted.

In another example, a checksum can be associated with the first software component SBOM 110a. The checksum can be a value computed based on the first metadata 112a in the first software component SBOM 110a. To verify that the first software component SBOM 110a has not been tampered with, the checksum can be recalculated. If the recalculated checksum does not match the checksum associated with the first software component SBOM 110a, it can be concluded that the first metadata 112a may have been altered or corrupted. In examples in which the hash value or the recalculated checksum do not match the digital signature or the checksum respectively, the OS management system 102 may generate an alert and transmit the alert to the computing system 104 or an associated user device (e.g., user device 138).

The OS management system 102 can further generate an operating system (OS) SBOM 108. The OS SBOM 108 can comprise the software component SBOMs 110a-b. Thus, the OS SBOM 108 can contain the metadata 112a-b for each of the software components 118a-b as provided in the software component SBOMs 110a-b. The software component SBOMs 110a-b, the OS SBOM 108, or the combination thereof can be generated upon determining that the operating system 124 is compliant with the functional safety standard 136 (e.g., via testing of each of the software components of the operating system 124). Consequently, the metadata 112a-b can represent the verified state 142 of the operating system 124. The verified state 142 of the operating system 124 can be the state in which the operating system 124 is compliant with the functional safety standard 136. That is, in the verified state 142, the operating system 124 can receive or maintain its functional safety certification.

As a result of generating the software component SBOMs 110a-b, the OS SBOM 108, or the combination thereof, the OS management system 102 can monitor a state of the operating system 124, verify ongoing compliance of the operating system 124 with the functional safety standard 136, or the like. To do so, the OS management system 102 can receive (e.g., access or request) the OS metadata 134 of the OS image 132. Then the OS management system 102 can compare the OS metadata 134 to the metadata 112a-b stored in the OS SBOM 108. Based on the comparison, the OS management system 102 can control execution of the software services 120, generate an alert 116, initiate an update workflow 114, or the like.

For example, based on the comparison of the OS metadata 134 to the metadata 112a-b, the OS management system 102 can determine that a current state 140 of the operating system 124 does not match the verified state 142. In a particular example, a configuration setting change can be made with respect to a second software component 118b (e.g., a memory manager) of the operating system 124. For example, the configuration setting change can involve an increase in an amount of memory allocated by the memory manager to a software application installed at the computing system 104. As a result, the OS metadata 134 can indicate the new configuration setting (e.g., the increased amount of memory allocated to the software application). But, the second metadata 112b for the second software component 118b in the OS SBOM 108 may include the amount of memory allocated before the configuration setting change. As a result, the OS management system 102 can determine that the current state 140 of the operating system 124 and the verified state 142 do not match.

In response to determining that the current state 140 and verified state 142 do not match, the OS management system 102 can generate an alert 116 with an indication of the discrepancy between the OS metadata 134 and the second metadata 112b. The alert 116 may further indicate that the function safety certification of the operating system 124 is invalid or should be reevaluated based on the configuration setting change. The OS management system 102 can then transmit the alert 116 to computing system 104 or a user device 138 associated with the computing system 104. For example, the user device 138 can be a laptop, smartphone, tablet, or the like communicatively coupled with the OS management system 102, the computing system 104, or a combination thereof via the network 130. Additionally or alternatively, the OS management system 102 can update the second metadata 112b in the second software component SBOM 110b to indicate that the memory manager increased the amount of memory allocated to the software application. In this way, the second software component SBOM 110b can be used to track changes to the second software component 118b over time.

In some examples, the OS management system 102 can be associated with a development pipeline the operating system 124. As a result, the OS management system 102 can automatically update the software component SBOMs 110a-b based on updates or changes to the operating system 124 during testing, development, or deployment. In an example, a second version of the first software component 118a (e.g., kernel) can become available for the operating system 124. The second version of the kevel can provide improved security for the operating system 124 in comparison with a first version of the kernel. Therefore, it can be desirable to efficiently detect and implement the update at the operating system 124. In some examples, it may be necessary to implement the update to maintain compliance with the functional safety standard 136.

As a result of the OS management system 102 being integrated into the development pipeline, the OS management system 102 can detect the second version of the kernel. In response, the OS management system 102 can update the first metadata 112a associated with the first software component 118a to indicate that second version of the kernel should be used at the operating system 124. But, if the update has not been carried out at the computing system 104, the OS metadata 134 may include the first version of the kernel. Consequently, upon comparison of the first metadata 112a and the OS metadata 134, the OS management system 102 can determine that the current state 140 and the verified state 142 do not match.

In response to determining that the current state 140 and the verified state 142 do not match, the OS management system 102 can generate the alert 116 with the indication of the discrepancy between the OS metadata 134 and the first metadata 112a. The alert 116 may further indicate that the function safety certification of the operating system 124 is invalid or should be reevaluated based on the update. The OS management system 102 can then transmit the alert 116 to computing system 104 or a user device 138 associated with the computing system 104. Additionally or alternatively, the OS management system 102 can automatically initiate an update workflow 114 at the computing system 104 to install the second version of the kernel. In this way, the OS management system 102 can facilitate efficient updates of the operating system 124, which can also facilitate compliance with the functional safety standard 136.

Additionally, in some examples, the OS management system 102 can provide the computing system 104 (e.g., software components 118a-b) access to one or more SBOM application programming interfaces (APIs). The SBOM APIs can be used by the computing system 104 to retrieve the metadata 112a-b from the OS SBOM 108, update the OS metadata 134, update the metadata 112a-b, or query or filter the OS SBOM 108 or the software component SBOMs 110a-b. Additionally, the SBOM APIs can enable the OS management system 102 to integrate SBOMs into tools for development, testing, and deployment of operating systems. The SBOM APIs can further enable the OS management system 102 to automatically generate and update the SBOMs based on the computing system 104.

The OS management system 102 may further, in some examples, store the software component SBOMs 110a-b, the OS SBOM 108, or a combination thereof in an SBOM repository 106. The software component SBOMs 110a-b, the OS SBOM 108, or the combination thereof can be updated, accessed, or the like from the SBOM repository 106. Thus, the software component SBOMs 110a-b, the OS SBOM 108, or the combination thereof can be used for updating, evaluating, or otherwise analyzing other suitable operating systems (e.g., other operating systems required to comply with the functional safety standard 136).

While FIG. 1 depicts a specific arrangement of components, other examples can include more components, fewer components, different components, or a different arrangement of the components shown in FIG. 1. For instance, in other examples, the OS SBOM 108 can include a different number of software component SBOMs 110a-b. Additionally, any component or combination of components depicted in FIG. 1 can be used to implement the process(es) described herein.

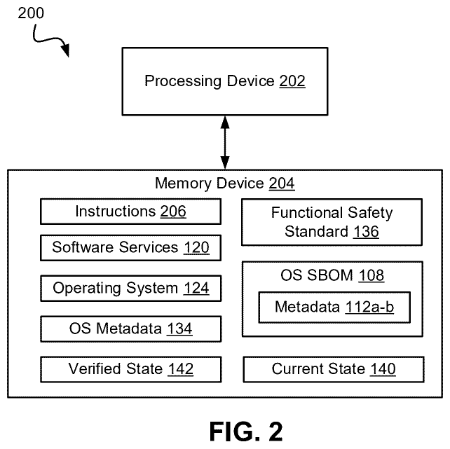

FIG. 2 is a block diagram of an example of a computing system 200 for executing operating systems based on software bill of materials (SBOMs) to facilitate safety compliance according to some embodiments of the present disclosure. The computing system 200 can include a processing device 202 communicatively coupled to a memory device 204.

The processing device 202 can include one processing device or multiple processing devices. The processing device 202 can be referred to as a processor. Non-limiting examples of the processing device 202 include a Field-Programmable Gate Array (FPGA), an application-specific integrated circuit (ASIC), and a microprocessor. The processing device 202 can execute instructions 206 stored in the memory device 204 to perform operations. In some examples, the instructions 206 can include processor-specific instructions generated by a compiler or an interpreter from code written in any suitable computer-programming language, such as C, C++, C#, Java, Python, or any combination of these.

The memory device 204 can include one memory device or multiple memory devices. The memory device 204 can be non-volatile and may include any type of memory device that retains stored information when powered off. Non-limiting examples of the memory device 204 include electrically erasable and programmable read-only memory (EEPROM), flash memory, or any other type of non-volatile memory. At least some of the memory device 204 includes a non-transitory computer-readable medium from which the processing device 202 can read instructions 206. A computer-readable medium can include electronic, optical, magnetic, or other storage devices capable of providing the processing device 202 with the instructions 206 or other program code executable to perform operations. Non-limiting examples of a computer-readable medium include magnetic disk(s), memory chip(s), ROM, random-access memory (RAM), an ASIC, a configured processor, and optical storage.

In some examples, the processing device 202 can execute the instructions 206 to perform operations. For example, the processing device 202 can receive first metadata (e.g., OS metadata 134) indicative of a current state 140 of an operating system 124. The operating system 124 can be used to execute one or more software services 120, and the operating system 124 can be associated with a functional safety standard 136 issued by a standard-setting organization. The processing device 202 can further determine whether the current state 140 of the operating system 124 matches a verified state 142 of the operating system 124 based on the OS metadata 134 and based on second metadata (e.g., metadata 112a-b) indicative of the verified state 142. The metadata 112a-b can be stored in an operating system (OS) software bill of material (SBOM) 108. Then, based on determining that the current state 140 of the operating system 124 matches the verified state 142, the processing device 202 can verify compliance of the operating system 124 with the function safety standard 136 and execute, via the operating system 124, the one or one software services 120.

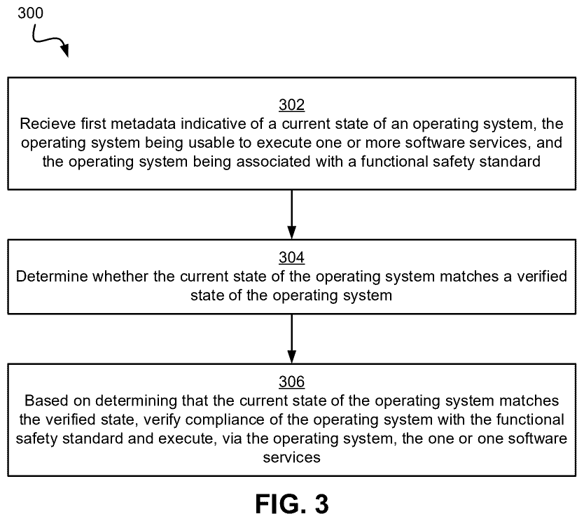

FIG. 3 is a flowchart of a process 300 for executing operating systems based on software bill of materials (SBOMs) to facilitate safety compliance according to some embodiments of the present disclosure. In some examples, the processing device 202 can perform one or more of the steps shown in FIG. 3. For example, the processing device 202 can execute the OS management system 102 of FIG. 1 to perform one or more of the steps shown in FIG. 3. In other examples, the processing device 202 can implement more steps, fewer steps, different steps, or a different order of the steps depicted in FIG. 3. The steps of FIG. 3 are described below with reference to components discussed above in FIGS. 1-2.

At block 302, the processing device 202 can receive first metadata (e.g., OS metadata 134) indicative of a current state 140 of an operating system 124. The operating system 124 can be used to execute one or more software services 120 and the operating system 124 can be associated with a functional safety standard 136 issued by a standard-setting organization.

In a particular example, the operating system 124 can be part of an automotive system. The functional safety standard 136 can be imposed on the operating system 124 due to the operating system 124 being part automotive system. The processing device 202 can be part of a separate device (e.g., computing system 200) that is communicatively coupled with the automotive system via a network (e.g., network 130). Thus, the processing device 202 can receive the OS metadata 134 from the automotive system via the network. The OS metadata 134 can be indicative of the current state 140 of the operating system 124 by providing an overview how the operating system 124 is functioning within a given timeframe. For example, the OS metadata 134 can provide information about software processes, resources allocations, configuration settings, or the like being carried out or managed by software components 118a-b of the operating system 124. More specifically, the OS metadata 134 can include version information, performance metrics (e.g., response times), resource usage (e.g., CPU or memory usage), or the like for each of the software components 118a-b.

At block 304, the processing device 202 can determine, based on the first metadata 134 and based on second metadata stored in an operating system (OS) software bill of material (SBOM) 108, whether the current state 140 of the operating system 124 matches a verified state 142 of the operating system 124. The second metadata can be indicative of the verified state 142 of the operating system 124. For example, the verified state 142 of the operating system 124 can be a state in which the operating system 124 satisfies one or more safety requirements of the functional safety standard 136. Thus, information associated with software processes, resources allocations, configuration settings, or the like being carried out or managed by the software components 118a-b of the operating system 124 when the safety requirements are met can be stored in the OS SBOM 108 as the second metadata.

In the particular example, the second metadata can include metadata 112a associated with a first software component 118a of the operating system 124. The second metadata can also include metadata 112b associated with a second software component 118b of the operating system 124. The first software component 118a can be a kernel and the second software component 118b can be a file management tool. The metadata 112a can therefore include version information (e.g., release number or build date), configuration settings (e.g., enabled features), module information (dependencies, configuration parameters, or the like for kernel modules), performance counters (e.g., CPU usage, memory usage, etc.), or other suitable information related to the kernel. The metadata 112b can include version information, configuration settings, supported file systems, user interface preferences, file operations history, or other suitable information related to the file management tool.

As described above, the second metadata for each of the software components 118a-b can be associated with the verified state 142 in which the operating system 124 satisfies safety requirements of the functional safety standard 136. Thus, by storing the second metadata in the OS SBOM 108, the processing device 202 can analyze the verified state 142 of the operating system 124 in an efficient manner. Then, to determine whether the current state 140 matches the verified state, the processing device 202 can compare the first metadata to the second metadata. In this way, the processing device 202 can determine if the software processes, resources allocations, configuration settings, or the like being carried out or managed by the operating system 124 have changed. If the software processes, resources allocations, configuration settings, or the like have not changed (e.g., if the current state 140 matches the verified state 142), it can be verified that the operating system 124 is compliant with the functional safety standard 136. In contrast, if there has been a change in the software processes, resources allocations, configuration settings, or the like, the operating system 124 may not be compliant with the functional safety standard 136.

At block 306, the processing device 202 can, based on determining that the current state 140 of the operating system 124 matches the verified state 142, verify compliance of the operating system 124 with the function safety standard 136 and execute, via the operating system 124, the one or one software services 120. In this way, the compliance of the operating system 124 with the functional safety standard 136 can be evaluated and verified in an efficient manner. As a result, the operating system 124 can continue to execute the software services 120 with minimal risk to the safety of a user of the automotive system.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure.

What is claimed is:

1. A system comprising:
a processing device; and
a memory device including instructions that are executable by the processing device for causing the processing device to perform operations comprising:
receiving first metadata indicative of a current state of an operating system, the operating system being usable to execute one or more software services, and the operating system being associated with a functional safety standard;
determining whether the current state of the operating system matches a verified state of the operating system based on the first metadata and based on second metadata indicative of the verified state, the second metadata being stored in an operating system software bill of material (SBOM); and
based on determining that the current state of the operating system matches the verified state, verifying compliance of the operating system with the functional safety standard and executing, via the operating system, the one or one software services.

2. The system of claim 1, wherein the operations further comprise generating a plurality of software component SBOMs, wherein each software component SBOM of the plurality of software component SBOMs comprises additional metadata associated with each software component of a plurality of software components, wherein the operating system comprises the plurality of software components.

3. The system of claim 2, wherein the operations further comprise generating the operating system SBOM using the plurality of software component SBOMs, wherein the second metadata in the operating system SBOM comprises the additional metadata associated with each software component of the of the plurality of software components.

4. The system of claim 1, wherein the operations further comprise, based on determining that the current state of the operating system does not match the verified state, updating at least one software component of the operating system.

5. The system of claim 1, wherein the operations further comprise, based on determining that the current state of the operating system does not match the verified state, generating an alert and transmitting the alert to a user device associated with the operating system.

6. The system of claim 1, wherein the operations further comprise providing access for the one or more software services associated with the operating system to one or more SBOM application programming interfaces.

7. The system of claim 1, wherein the second metadata comprises a digital signature or a checksum.

8. A method comprising:
receiving first metadata indicative of a current state of an operating system, the operating system being usable to execute one or more software services, and the operating system being associated with a functional safety standard;
determining whether the current state of the operating system matches a verified state of the operating system based on the first metadata and based on second metadata indicative of the verified state, the second metadata being stored in an operating system software bill of material (SBOM); and
based on determining that the current state of the operating system matches the verified state, verifying compliance of the operating system with the functional safety standard and executing, via the operating system, the one or one software services.

9. The method of claim 8, further comprising generating a plurality of software component SBOMs, wherein each software component SBOM of the plurality of software component SBOMs comprises additional metadata associated with each software component of a plurality of software components, wherein the operating system comprises the plurality of software components.

10. The method of claim 9, further comprising generating the operating system SBOM using the plurality of software component SBOMs, wherein the second metadata in the operating system SBOM comprises the additional metadata associated with each software component of the of the plurality of software components.

11. The method of claim 8, further comprising, based on determining that the current state of the operating system does not match the verified state, updating at least one software component of the operating system.

12. The method of claim 8, further comprising, based on determining that the current state of the operating system does not match the verified state, generating an alert and transmitting the alert to a user device associated with the operating system.

13. The method of claim 8, further comprising providing access for the one or more software services associated with the operating system to one or more SBOM application programming interfaces.

14. The method of claim 8, wherein the second metadata comprises a digital signature or a checksum.

15. A non-transitory computer-readable medium comprising program code executable by a processing device for causing the processing device to perform operations comprising:
receiving first metadata indicative of a current state of an operating system, the operating system being usable to execute one or more software services, and the operating system being associated with a functional safety standard;
determining whether the current state of the operating system matches a verified state of the operating system based on the first metadata and based on second metadata indicative of the verified state, the second metadata being stored in an operating system software bill of material (SBOM); and
based on determining that the current state of the operating system matches the verified state, verifying compliance of the operating system with the functional safety standard and executing, via the operating system, the one or one software services.

16. The non-transitory computer-readable medium of claim 15, wherein the operations further comprise generating a plurality of software component SBOMs, wherein each software component SBOM of the plurality of software component SBOMs comprises additional metadata associated with each software component of a plurality of software components, wherein the operating system comprises the plurality of software components.

17. The non-transitory computer-readable medium of claim 16, wherein the operations further comprise generating the operating system SBOM using the plurality of software component SBOMs, wherein the second metadata in the operating system SBOM comprises the additional metadata associated with each software component of the of the plurality of software components.

18. The non-transitory computer-readable medium of claim 15, wherein the operations further comprise, based on determining that the current state of the operating system does not match the verified state, updating at least one software component of the operating system.

19. The non-transitory computer-readable medium of claim 15, wherein the operations further comprise, based on determining that the current state of the operating system does not match the verified state, generating an alert and transmitting the alert to a user device associated with the operating system.

20. The non-transitory computer-readable medium of claim 15, wherein the operations further comprise providing access for the one or more software services associated with the operating system to one or more SBOM application programming interfaces.
